(19) United States
(12) Patent Application Publication
(10) Pub. No.: US 2026/0067883 A1
(43) Pub. Date: Mar. 5, 2026

(54) DOWNLINK-REFERENCE SIGNAL (DL-RS) BASED DATA COLLECTION TO SUPPORT BEAM PAIR PREDICTION MODEL TRAINING

(71) Applicant: Telefonaktiebolaget LM Ericsson (publ), Stockholm (SE)

(72) Inventors: Andreas NILSSON, Göteborg (SE); Jingya LI, Göteborg (SE); Icaro Leonardo DA SILVA, Solna (SE); Chunhui LI, Yokohama, Kanagawa (JP); Henrik RYDÉN, Stockholm (SE)

(21) Appl. No.: 19/101,656

(22) PCT Filed: Aug. 10, 2023
(86) PCT No.: PCT/SE2023/050805

§ 371 Date: Feb. 6, 2025

Related U.S. Application Data
(60) Provisional application No. 63/397,621, filed on Aug. 12, 2022.

(51) Int. Cl. H04W 72/044; H04L 5/00; H04W 72/51

(52) U.S. Cl. CPC H04W 72/046; H04L 5/0048; H04W 72/51

(57) ABSTRACT

A method, system and apparatus are disclosed. In one or more embodiments, a wireless device is configured to receive a beam pair link configuration indicating a plurality of beam pair links, where each beam pair link corresponds to a mapping between a network node beam and a wireless device beam. The wireless device is further configured to perform at least one measurement of at least one of the plurality of beam pair links.

### TECHNICAL FIELD

The present disclosure relates to wireless communications, and in particular, to beam pair link prediction using, for example, a trained machine learning model.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WDs), as well as communication between network nodes and between wireless devices. Sixth Generation (6G) wireless communication systems are also under development.

### Beam Management

### Beam Management Procedure

In high frequency range (FR2), multiple radio frequency (RF) beams may be used to transmit and receive signals at a network node and a wireless device. For each downlink (DL) beam from a network node, there is typically an associated best wireless device Rx beam for receiving signals from the DL beam. The DL beam and the associated wireless device Rx beam forms a beam pair. The beam pair can be identified through a beam management process in NR.

A DL beam is (typically) identified by an associated DL reference signal (RS) transmitted in the beam, either periodically, semi-persistently, or aperiodically. The DL RS for the purpose can be a Synchronization Signal (SS) and Physical Broadcast Channel (PBCH) block (SSB) or a Channel State Information RS (CSI-RS). By measuring all the DL RSs, the wireless device can determine and report to the network node the best DL beam to use for DL transmissions. The network node can then transmit a burst of DL-RS in the reported best DL beam to let the wireless device evaluate candidate wireless device receive (RX) beams.

Although not explicitly stated in the NR/3GPP specification, beam management has been divided into three procedures, schematically illustrated in FIG. 1:
P-1: Purpose is to find a coarse direction for the wireless device using wide network node TX beam covering the whole angular sector
P-2: Purpose is to refine the network node TX beam by performing a new beam search around the coarse direction found in P1.
P-3: Used for wireless device that has analog beamforming to let them find a suitable wireless device RX beam.

### Further Details Related to P-1 to P-3

P-1 is expected to utilize beams with rather large beamwidths and where the beam reference signals are transmitted periodically and are shared between all wireless devices of the cell. Typically reference signal to use for P-1 are periodic channel state information-reference signal (CSI-RS) or synchronization signal block (SSB). The wireless device then reports the N best beams to the network node and their corresponding received signal received power (RSRP) values.
P-2 is expected to use aperiodic/or semi-persistent CSI-RS transmitted in narrow beams around the coarse direction found in P-1.
P-3 is expected to use aperiodic or semi-persistent CSI-RSs repeatedly transmitted in one narrow network node beam. One alternative way is to let the wireless device determine a suitable wireless device RX beam based on the periodic SSB transmission. Since each SSB consists of four orthogonal frequency-division multiplexing (OFDM) symbols, a maximum of four wireless device RX beams can be evaluated during each SSB burst transmission. One benefit with using SSB instead of CSI-RS is that no extra overhead of CSI-RS transmission is needed.

### Beam Indication

In NR, several signals can be transmitted from different antenna ports of a same network node. These signals can have the same large-scale properties such as Doppler shift/spread, average delay spread, or average delay. These antenna ports are then said to be quasi co-located (QCL).

If the wireless device knows that two antenna ports are QCL with respect to a certain parameter (e.g., Doppler spread), the wireless device can estimate that parameter based on one of the antenna ports and apply that estimate for receiving signal on the other antenna port.

For example, there may be a QCL relation between a CSI-RS for tracking reference signal (TRS) and the physical downlink shared channel (PDSCH) demodulation reference signal (DMRS). When the wireless device receives the PDSCH DMRS it can use the measurements already made on the TRS to assist the DMRS reception.

Information about what assumptions can be made regarding QCL is signaled to the wireless device from the network node. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced in NR to facilitate beam management with analog beamforming and is known as spatial QCL. There is currently no strict definition of spatial QCL, but it may refer to the situation where if two transmitted antenna ports are spatially QCL, the wireless device can use the same Rx beam to receive them. This is helpful for a wireless device that uses analog beamforming to receive signals, since the wireless device needs to adjust its RX beam in some direction prior to receiving a certain signal. If the wireless device knows that the signal is spatially QCL with some other signal it has received earlier, then it can safely (e.g., interference-wise) use the same RX beam to receive this signal.

In NR, the spatial QCL relation for a DL or uplink (UL) signal/channel can be indicated to the wireless device by using a “beam indication”. The “beam indication” is used to help the wireless device to find a suitable RX beam for DL reception, and/or a suitable TX beam for UL transmission. In NR, the “beam indication” for DL is conveyed to the wireless device by indicating a transmission configuration indicator (TCI) state to the wireless device, while in UL the “beam indication” can be conveyed by indicating a DL-RS or UL-RS as spatial relation (in NR/3GPP Release-15/16 (Rel-15/16)) or a TCI state (in 3GPP NR rel-17).

Beam Management with Unified TCI Framework

In NR, downlink beam management is performed by conveying spatial QCL (‘Type D’) assumptions to the wireless device through TCI states.

In 3GPP NR Rel-15 or Rel-16, for physical downlink control channel (PDCCH), the network (NW)/network node configures the wireless device with a set of PDCCH TCI states by radio resource control (RRC), and then activates one TCI state per CORESET using MAC CE. For PDSCH beam management, the NW/network node configures the wireless device with a set of PDSCH TCI states by RRC, and then activates up to 8 TCI states by MAC CE. After activation, the NW/network node dynamically indicates one of these activated TCI states using a TCI field in DCI when scheduling PDSCH.

Such a framework allows flexibility for the network/network node to instruct the wireless device to receive signals from different spatial directions in DL with a cost of large signaling overhead and slow beam switch. These limitations are particularly noticeable and costly when wireless device movement is considered. One example is that beam update using DCI can only be performed for PDSCH, and MAC-CE and/or RRC is required to update the beam for other reference signals/channels, with causes extra overhead and latency.

Furthermore, in some cases, the network/network node transmits to and receives from a wireless device in the same direction for both data and control. Hence, using separate framework (TCI state respective spatial relations) for different channels/signals complicates the implementations.

In 3GPP Rel-17, a common beam framework was introduced to help simplify beam management in FR2, in which a common beam represented by a TCI state may be activated/indicated to a wireless device and the common beam is applicable for multiple channels/signals such as PDCCH and PDSCH. The common beam framework is also referred to a unified TCI state framework.

The new framework can be RRC configured in one out two modes of operation, i.e., “Joint DL/UL TCI” or “Separate DL/UL TCI”. For “Joint DL/UL TCI”, one common Joint TCI state is used for both DL and UL signals/channels. For “Separate DL/UL TCI”, one common DL-only TCI state is used for DL channels/signals and one common UL-only TCI state is used for UL signals/channels.

A unified TCI state can be updated in a similar way as the TCI state update for PDSCH in Rel-15/16, i.e. with one of two alternatives:
Two-stage: RRC signaling is used to configure a number unified TCI states in higher layer parameter PDSCH-config, and a MAC-CE is used to activate one of unified TCI states
Three-stage: RRC signaling is used to configure a number unified TCI states in PDSCH-config, a MAC-CE is used to activate up to 8 unified TCI states, and a 3-bit TCI state bitfield in DCI is used to indicate one of the activate unified TCI states.

The one activated or indicated unified TCI state may be used in subsequent both PDCCH and PDSCH transmissions until a new unified TCI state is activated or indicated.

The existing DCI formats 1_1 and 1_2 are reused for beam indication, both with and without DL assignment. For DCI formats 1_1 and 1_2 with DL assignment, acknowledgement/negative acknowledgement (ACK/NACK) of the PDSCH can be used as indication of successful reception of beam indication. For DCI formats 1_1 and 1_2 without DL assignment, an new ACK/NACK mechanism analogous to that for SPS PDSCH release with both type-1 and type-2 HARQ-ACK codebook is used, where upon a successful reception of the beam indication downlink control information (DCI), the wireless device reports an ACK.

For DCI-based beam indication, the first slot to apply the indicated TCI is at least Y symbols after the last symbol of the acknowledgment of the joint or separate DL/UL beam indication. The Y symbols are configured by the network node based on wireless device capability, which is also reported in units of symbols. The values of Y are yet not determined and were left to radio access network 4 (RAN4) to decide.

### Reference Signal

### Reference Signal Configurations

### CSI-RS:

A CSI-RS is transmitted over each transmit (Tx) antenna port at the network node and for different antenna ports. The CSI-RS are multiplexed in time, frequency, and code domain such that the channel between each Tx antenna port at the network node and each receive antenna port at a wireless device can be measured by the wireless device. The time-frequency resource used for transmitting CSI-RS is referred to as a CSI-RS resource.

In NR, the CSI-RS for beam management is defined as a 1- or 2-port CSI-RS resource in a CSI-RS resource set where the filed repetition is present. The following three types of CSI-RS transmissions are supported:
Periodic CSI-RS: CSI-RS is transmitted periodically in certain slots. This CSI-RS transmission is semi-statically configured using RRC signaling with parameters such as CSI-RS resource, periodicity, and slot offset.
Semi-Persistent CSI-RS: Similar to periodic CSI-RS, resources for semi-persistent CSI-RS transmissions are semi-statically configured using RRC signaling with parameters such as periodicity and slot offset. However, unlike periodic CSI-RS, dynamic signaling is needed to activate and deactivate the CSI-RS transmission.
Aperiodic CSI-RS: This is a one-shot CSI-RS transmission that can happen in any slot. Here, one-shot means that CSI-RS transmission only happens once per trigger. The CSI-RS resources (i.e., the RE locations which consist of subcarrier locations and OFDM symbol locations) for aperiodic CSI-RS are semi-statically configured. The transmission of aperiodic CSI-RS is triggered by dynamic signaling through PDCCH using the CSI request field in UL DCI, in the same DCI where the UL resources for the measurement report are scheduled. Multiple aperiodic CSI-RS resources can be included in a CSI-RS resource set and the triggering of aperiodic CSI-RS is on a resource set basis.

### SSB:

In NR, an SSB consists of a pair of synchronization signals (SSs), physical broadcast channel (PBCH), and DMRS for PBCH. A SSB is mapped to 4 consecutive OFDM symbols in the time domain and 240 contiguous subcarriers (20 RBs) in the frequency domain.

To support beamforming and beam-sweeping for SSB transmission, in NR, a cell can transmit multiple SSBs in different narrow-beams via time multiplexing. The transmission of these SSBs is confined to a half frame time interval (5 ms). It is also possible to configure a cell to transmit multiple SSBs in a single wide-beam with multiple repetitions. The design of beamforming parameters for each of the SSBs within a half frame is up to network implementation. The SSBs within a half frame are broadcasted periodically from each cell. The periodicity of the half frames with SS/PBCH blocks is referred to as SSB periodicity, which is indicated by SIB1.

The maximum number of SSBs within a half frame, denoted by L, depends on the frequency band, and the time locations for these L candidate SSBs within a half frame depends on the SCS of the SSBs. The L candidate SSBs within a half frame are indexed in an ascending order in time from 0 to L−1. By successfully detecting PBCH and its associated DMRS, a wireless device knows the SSB index. A cell does not necessarily transmit SS/PBCH blocks in all L candidate locations in a half frame, and the resource of the un-used candidate positions can be used for the transmission of data or control signaling instead. It is up to network implementation to decide which candidate time locations to select for SSB transmission within a half frame, and which beam to use for each SSB transmission

### Measurement Resource Configurations

In NR, a wireless device can be configured with N≥1 CSI reporting settings (i.e., CSI-ReportConfig), M≥1 resource settings (i.e., CSI-ResourceConfig), where each CSI reporting setting is linked to one or more resource settings for channel and/or interference measurement. The CSI framework is modular, meaning that several CSI reporting settings may be associated with the same Resource Setting.

The measurement resource configurations for beam management are provided to the wireless device by RRC IEs CSI-ResourceConfigs. One CSI-ResourceConfig contains several NZP-CSI-RS-ResourceSets and/or CSI-SSB-ResourceSets.

A wireless device can be configured to perform measurement on CSI-RSs. Here the RRC information element (IE) NZP-CSI-RS-ResourceSet is used. A non zero power (NZP) CSI-RS resource set contains the configuration of Ks≥1 CSI-RS resources, where the configuration of each CSI-RS resource includes at least: mapping to REs, the number of antenna ports, time-domain behavior, etc. Up to 64 CSI-RS resources can be grouped to a NZP-CSI-RS-ResourceSet. A wireless device can also be configured to perform measurements on SSBs. Here, the RRC information element (IE) CSI-SSB-ResourceSet is used. Resource sets comprising SSB resources are defined in a similar manner.

In the case of aperiodic CSI-RS and/or aperiodic CSI reporting, the network node configures the wireless device with S_c CSI triggering states. Each triggering state contains the aperiodic CSI report setting to be triggered along with the associated aperiodic CSI-RS resource sets.

Periodic and semi-persistent Resource Settings can only comprise a single resource set (i.e., S=1) while S>=1 for aperiodic Resource Settings. This is because, in the aperiodic case, one out of the S resource sets comprised in the Resource Setting is indicated by the aperiodic triggering state that triggers a CSI report.

### Measurement Reporting

Three types of CSI reporting are supported in NR as follows:
Periodic CSI Reporting on physical uplink control channel (PUCCH): CSI is reported periodically by a wireless device. Parameters such as periodicity and slot offset are configured semi-statically by higher layer RRC signaling from the network node to the wireless device.
Semi-Persistent CSI Reporting on physical uplink shared channel (PUSCH) or PUCCH: similar to periodic CSI reporting, semi-persistent CSI reporting has a periodicity and slot offset which may be semi-statically configured. However, a dynamic trigger from network node to wireless device may be needed to allow the wireless device to begin semi-persistent CSI reporting. A dynamic trigger from network node to wireless device is needed to request the wireless device to stop the semi-persistent CSI reporting.
Aperiodic CSI Reporting on PUSCH: This type of CSI reporting involves a single-shot (i.e., one time) CSI report by a wireless device which is dynamically triggered by the network node using DCI. Some of the parameters related to the configuration of the aperiodic CSI report is semi-statically configured by RRC but the triggering is dynamic.

In each CSI reporting setting, the content and time-domain behavior of the report is defined, along with the linkage to the associated Resource Settings. The CSI-ReportConfig IE comprise the following configurations:
reportConfigType
   Defines the time-domain behavior, i.e., periodic CSI reporting, semi-persistent CSI reporting, or aperiodic CSI reporting, along with the periodicity and slot offset of the report for periodic CSI reporting.
reportQuantity
   Defines the reported CSI parameter(s) (i.e., the CSI content), such as PMI, CQI, RI, LI (layer indicator), CRI (CSI-RS resource index) and L1-RSRP. Only a certain number of combinations are possible (e.g. ‘cri-RI-PMI-CQI’ is one possible value and ‘cri-RSRP’ is another) and each value of reportQuantity could be said to correspond to a certain CSI mode.
codebookConfig
   Defines the codebook used for PMI reporting, along with possible codebook subset restriction (CBSR). Two “Types” of PMI codebook are defined in NR, Type I CSI and Type II CSI, each codebook type further has two variants each.
reportFrequencyConfiguration
   Define the frequency granularity of PMI and CQI (wideband or subband), if reported, along with the CSI reporting band, which is a subset of subbands of the bandwidth part (BWP) which the CSI corresponds to
Measurement restriction in time domain (ON/OFF) for channel and interference respectively

For beam management, a wireless device can be configured to report L1-RSRP for up to four different CSI-RS/SSB resource indicators. The reported RSRP value corresponding to the first (best) CRI/SSBRI requires 7 bits, using absolute values, while the others require 4 bits using encoding relative to the first. In NR release 16, the report of L1-SINR for beam management has already been supported.

### Beam Prediction

One example article intelligence/machine learning (AI/ML)-model currently discussed in the AI for air-interface 3GPP Rel-18 includes predicting the channel in respect to a beam for a certain time-frequency resource. The expected performance of such predictor depends on several different aspects, for example time/frequency variation of channel due to wireless device mobility or changes in the environment. Due to the inherit correlation in time, frequency and the spatial domain of the channel, an ML-model can be trained to exploit such correlations. The spatial domain can include of different beams, where the correlation properties partly depend on the how the network node antennas forms the different beams, and how wireless device forms the receiver beams.

The device can use such prediction ML-model to reduce its measurement related to beamforming. In NR, one can request a device to measure on a set of SSB beams or/and CSI-RS beams. A stationary device typically experiences less variations in beam quality in comparison to a moving device. The stationary device can therefore save battery and reduce the number of beam measurements by instead using an ML model to predict the beam quality without an explicit measurement. It can do this, for example, by measuring a subset of the beams and predicting the rest of the beams. In one example, AI can be used to measure a subset of beams in order to predict the best beam, which can reduce up to 75% measurement time.

In one existing, a wireless device is enabled to predict future beam values based on historical values. Based on received device data from measurement reports, the network node can learn, for example, which sequences of signal quality measurements (e.g., RSRP measurements) lead to large signal quality drop events (e.g., turning around the corners in FIG. 2, described below). This learning procedure can be enabled, for example, by dividing periodically reported RSRP data into a training and prediction window.

In the example shown in FIG. 2, two devices (e.g., wireless devices) move and turn around the same corner. Device 120b, marked by dashed line, is the first to turn around the corner and experience a large signal quality drop. The idea is to mitigate the drop of a second device (120a) by using learning from the first device's experiences.

The learning can be performed by feeding RSRP in t1, . . . , tn into a machine learning model (e.g., neural network), and then learn the RSRP in tn+1, tn+2. After the model is trained, the network node can then predict future signal quality values, the signal quality prediction can then be used to avoid radio-link failure, or beam failure, by:
Initiate inter-frequency handover
Set handover/reselection parameters
Pre-emptively perform candidate beam selection to avoid beam failure
Change device scheduler priority, for example schedule device when the expected signal quality is good.

One issue with AI/ML based network node TX beam prediction is that the network node has no knowledge of what wireless device panel and/or wireless device beam the wireless device is using. Since the wireless device might use different wireless device panels/wireless device beams during the data training procedure then what it is using during the inference procedure, the prediction of the network node TX beam at the network side becomes difficult.

So far, discussion regarding AI/ML-based beam management procedure has at least in part focused on determining a preferred network node beam. One issue with this is that it usually takes a long time for the wireless device to determine a suitable wireless device beam for a given network node beam. An internal mmWave measurement discussion/experiment showed that it can take up to 1 sec for a wireless device to find a suitable wireless device beam. In case a wireless device is moving/rotating, the delay of one second to find a suitable wireless device beam will significantly reduce the performance.

Hence, the existing system are not without issues with respect to beam management.

### SUMMARY

Some embodiments advantageously provide methods, systems, and apparatuses for beam pair link prediction using, for example, a trained machine learning model.

In one or more embodiments described herein relate to one or more methods at a wireless device for assisting a network function (e.g., network node) to perform data collection for AI/ML based network-sided beam pair link prediction based on DL reference signals, the one or more methods includes:
receiving a message containing a DL reference signal configuration
receiving a message containing a CSI Beam Pair Link Report configuration
receive an indication of a mapping between a wireless device beam and an DL reference signal/DL measurement
receiving a trigger message to measure according to the CSI Beam Pair Link Report configuration
perform measurements on the DL reference signals using the associated wireless device beams according to the received mapping between DL reference signals/DL measurements and wireless device beams
report preferred reference signals/beam pair links
(Optionally) provide the network with wireless device assistance information.

According to one aspect of the present disclosure, a method implemented by a wireless device that is configured to communicate with a network node is provided. A beam pair link configuration indicating a plurality of beam pair links is received where each beam pair link corresponds to a mapping between a network node beam and a wireless device beam. At least one measurement is performed of at least one of the plurality of beam pair links.

According to some embodiments of this aspect, wireless device capability information is transmitted to the network node, and the beam pair link configuration is configured based the wireless device capability.

According to some embodiments of this aspect, the wireless device capability includes at least one of: a total number of wireless device beams usable for beam pair link data collection, a total number of wireless device panels usable for beam pair link data collection, a number of beams per wireless device panel usable for beam pair link data collection, a number of beams per indicated wireless device panel usable for beam pair link data collection, a number of simultaneously receiving wireless device panels, information about which beams belongs to which wireless device panel, information about which beams are usable for simultaneous reception, a configuration identifier associated with an antenna configuration and/or beam configuration, wireless device panel switching time, or antenna gain for a respective wireless device beam.

According to some embodiments of this aspect, an indication to perform the at least one measurement on a subset of the plurality of beam pair links is received.

According to some embodiments of this aspect, each beam pair link of the plurality of beam pair links is associated with one of: a beam pair link identifier, or a downlink reference signal, DL-RS, resource index.

According to some embodiments of this aspect, each beam pair link of the plurality of beam pair links is associated with a wireless device beam index and a network node beam index.

According to some embodiments of this aspect, the network node beam index is one of: a downlink reference signal, DL-RS, resource index or a DL-RS resource index associated with a repetition index.

According to some embodiments of this aspect, a measurement of a beam pair link is omitted from the signaled data, where the omitted measurement being below a predefined threshold.

According to some embodiments of this aspect, assistance data is transmitted to the network node, where the beam pair link configuration is based at least on the assistance data, and the assistance data includes at least one of: wireless device rotation angle, wireless device position, at least one wireless device beam that is blocked, at least one wireless device panel that is blocked, or wireless antenna and/or beam configuration identifier.

According to some embodiments of this aspect, data associated with the at least one measurement is signaled.

According to another aspect of the present disclosure, a wireless device is configured to: receive a beam pair link configuration indicating a plurality of beam pair links, where each beam pair link corresponds to a mapping between a network node beam and a wireless device beam, and perform at least one measurement of at least one of the plurality of beam pair links.

According to some embodiments of this aspect, the wireless device is further configured to transmit wireless device capability information to the network node, and the beam pair link configuration is configured based the wireless device capability.

According to some embodiments of this aspect, the wireless device capability includes at least one of: a total number of wireless device beams usable for beam pair link data collection, a total number of wireless device panels usable for beam pair link data collection, a number of beams per wireless device panel usable for beam pair link data collection, a number of beams per indicated wireless device panel usable for beam pair link data collection, a number of simultaneously receiving wireless device panels, information about which beams belongs to which wireless device panel, information about which beams are usable for simultaneous reception, a configuration identifier associated with an antenna configuration and/or beam configuration, wireless device panel switching time, or antenna gain for a respective wireless device beam.

According to some embodiments of this aspect, the wireless device is further configured to receive an indication to perform the at least one measurement on a subset of the plurality of beam pair links.

According to some embodiments of this aspect, each beam pair link of the plurality of beam pair links is associated with one of: a beam pair link identifier, or a downlink reference signal, DL-RS, resource index.

According to some embodiments of this aspect, each beam pair link of the plurality of beam pair links is associated with a wireless device beam index and a network node beam index.

According to some embodiments of this aspect, the network node beam index is one of: a downlink reference signal, DL-RS, resource index, or a DL-RS resource index associated with a repetition index.

According to some embodiments of this aspect, the wireless device is further configured to omit a measurement of a beam pair link from the signaled data, where the omitted measurement is below a predefined threshold.

According to some embodiments of this aspect, the wireless device is further configured to transmit assistance data to the network node, where the beam pair link configuration is based at least on the assistance data, the assistance data including at least one of: wireless device rotation angle, wireless device position, at least one wireless device beam that is blocked, at least one wireless device panel that is blocked, or wireless antenna and/or beam configuration identifier.

According to one or more embodiments of this aspect, the wireless device is further configured to signal data associated with the at least one measurement.

According to another aspect of the present disclosure, a method implemented by a network node that is configured to communicate with a wireless device is provided. A beam pair link configuration is indicated to the wireless device, where the beam configuration indicates a plurality of beam pair links, and each beam pair link corresponds to a mapping between a network node beam and a wireless device beam. Data associated with a measurement of at least one of the plurality of beam pair links is received. At least one action is performed based on the data.

According to some embodiments of this aspect, at least one downlink reference signal associated with a subset of the plurality of beam pair links is transmitted.

According to some embodiments of this aspect, the at least one action includes predicating channel state information, CSI, associated with a beam pair link that is not part of the at least one of the plurality of beam pair links associated with the at least one measurement.

According to some embodiments of this aspect, wireless device capability information is received from the wireless device, and the beam pair link configuration is determined based the wireless device capability.

According to some embodiments of this aspect, the wireless device capability includes at least one of: a total number of wireless device beams usable for beam pair link data collection, a total number of wireless device panels usable for beam pair link data collection, a number of beams per wireless device panel usable for beam pair link data collection, a number of beams per indicated wireless device panel usable for beam pair link data collection, a number of simultaneously receiving wireless device panels, information about which beams belongs to which wireless device panel, information about which beams are usable for simultaneous reception, a configuration identifier associated with an antenna configuration and/or beam configuration, wireless device panel switching time, or antenna gain for a respective wireless device beam.

According to some embodiments of this aspect, an indication is transmitted to perform the at least one measurement on a subset of the plurality of beam pair links.

According to some embodiments of this aspect, each beam pair link of the plurality of beam pair links is associated with one of: a beam pair link identifier, or a downlink reference signal, DL-RS, resource index.

According to some embodiments of this aspect, each beam pair link of the plurality of beam pair links is associated with a wireless device beam index and a network node beam index.

According to some embodiments of this aspect, the network node beam index is one of: a downlink reference signal, DL-RS, resource index, or a DL-RS resource index associated with a repetition index.

According to some embodiments of this aspect, the data does not include a measurement of a beam pair link that is below a predefined threshold.

According to some embodiments of this aspect, assistance data is received from the wireless device, where the beam pair link configuration is based at least on the assistance data and the assistance data includes at least one of: wireless device rotation angle, wireless device position, at least one wireless device beam that is blocked, at least one wireless device panel that is blocked, or wireless antenna and/or beam configuration identifier.

According to another aspect of the present disclosure, a network node is provided. The network node is configured to indicate a beam pair link configuration to the wireless device, where the beam configuration indicates a plurality of beam pair links, and where each beam pair link corresponds to a mapping between a network node beam and a wireless device beam. The network node is configured to receive data associated with a measurement of at least one of the plurality of beam pair links, and perform at least one action based on the data.

According to some embodiments of this aspect, the network node is configured to transmit at least one downlink reference signal associated with a subset of the plurality of beam pair links.

According to some embodiments of this aspect, the at least one action includes predicating channel state information, CSI, associated with a beam pair link that is not part of the at least one of the plurality of beam pair links associated with the at least one measurement.

According to some embodiments of this aspect, the network node is further configured to: receive wireless device capability information from the wireless device, and determine the beam pair link configuration based the wireless device capability.

According to some embodiments of this aspect, the wireless device capability includes at least one of: a total number of wireless device beams usable for beam pair link data collection, a total number of wireless device panels usable for beam pair link data collection, a number of beams per wireless device panel usable for beam pair link data collection, a number of beams per indicated wireless device panel usable for beam pair link data collection, a number of simultaneously receiving wireless device panels, information about which beams belongs to which wireless device panel, information about which beams are usable for simultaneous reception, a configuration identifier associated with an antenna configuration and/or beam configuration, wireless device panel switching time, or antenna gain for a respective wireless device beam.

According to some embodiments of this aspect, the network node is further configured to transmit an indication to perform the at least one measurement on a subset of the plurality of beam pair links.

According to some embodiments of this aspect, each beam pair link of the plurality of beam pair links is associated with one of: a beam pair link identifier, or a downlink reference signal, DL-RS, resource index.

According to some embodiments of this aspect, each beam pair link of the plurality of beam pair links is associated with a wireless device beam index and a network node beam index.

According to some embodiments of this aspect, the network node beam index is one of: a downlink reference signal, DL-RS, resource index, or a DL-RS resource index associated with a repetition index.

According to some embodiments of this aspect, the data does not include a measurement of a beam pair link that is below a predefined threshold.

According to some embodiments of this aspect, the network node is further configured to receive assistance data from the wireless device, where the beam pair link configuration is based at least on the assistance data, and where the assistance data includes at least one of: wireless device rotation angle, wireless device position, at least one wireless device beam that is blocked, at least one wireless device panel that is blocked, or wireless antenna and/or beam configuration identifier.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example of a beam management procedure;

FIG. 2 is an example of two wireless devices moving on similar paths;

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node according to some embodiments of the present disclosure;

FIG. 10 is a flowchart of an example process in a network node according to some embodiments of the present disclosure;

FIG. 11 is a flowchart of an example process in a wireless device according to some embodiments of the present disclosure;

FIG. 12 is a flowchart of an example process in a wireless device according to some embodiments of the present disclosure;

FIG. 13 is a diagram of an example of beam pair links between a wireless device and a network node, and an association between CSI-RS resources, wireless device beams and beam pair links;

FIG. 14 is a diagram of an example of multi-TRPs scenario for determining the mapping between DL-RS resources to wireless device beams determined by the network node taking only the number of wireless device panels into account;

FIG. 15 is a diagram of an example of multi-TRPs scenario for determining the mapping between DL-RS resources to wireless device beams determined by the network node taking both the number of TRPs and the number of wireless device panels into account; and

FIG. 16 is a flowchart of an example process according to one or more embodiments of the present disclosure.

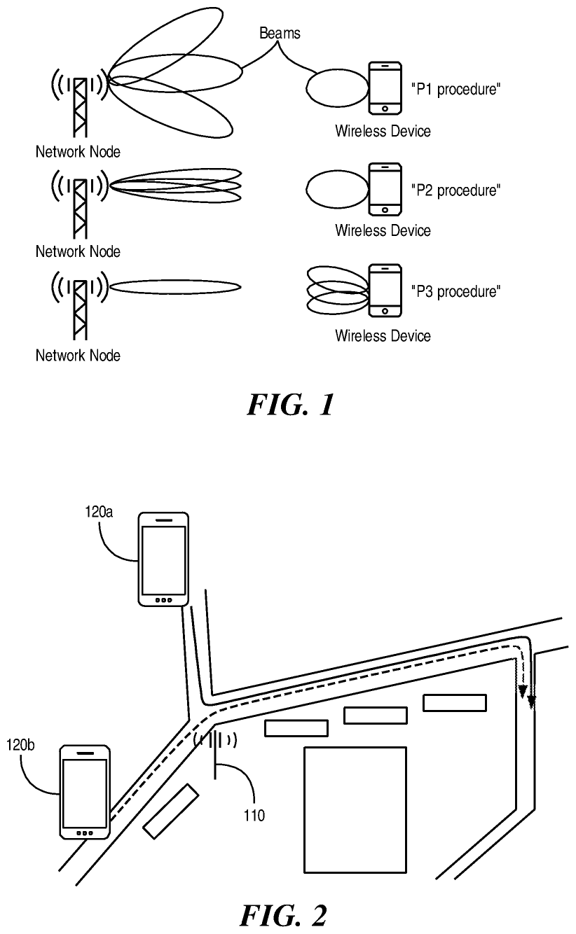

### DETAILED DESCRIPTION

Before describing in detail example embodiments, it is noted that the embodiments reside primarily in combinations of apparatus components and processing steps related to beam pair link prediction using, for example, a trained machine learning model. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide beam pair link prediction using, for example, a trained machine learning model.

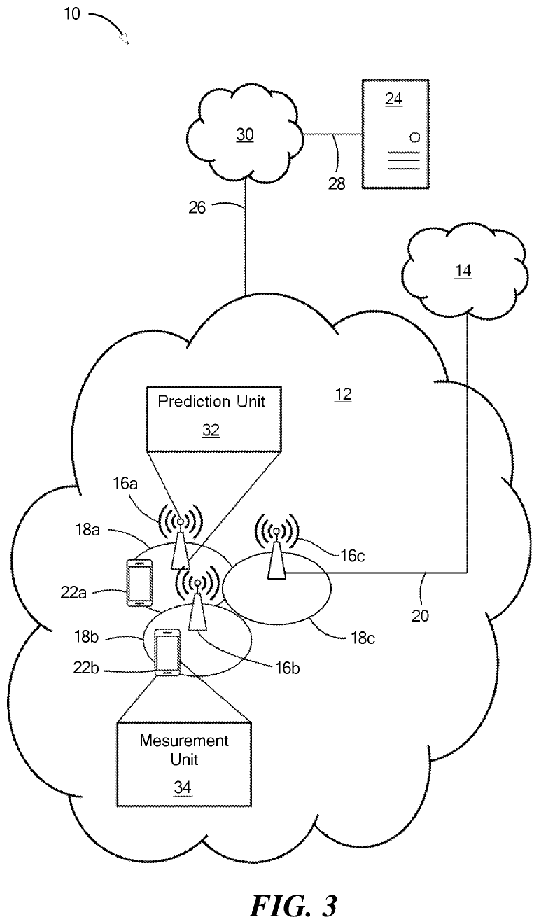

Referring now to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a prediction unit 32 which is configured to perform one or more network node 16 functions described herein such as with respect to, for example, beam pair link prediction using, for example, a trained machine learning model. A wireless device 22 is configured to include a measurement unit 34 which is configured to perform one or more wireless device 22 functions as described herein such as with respect to, for example, beam pair link prediction using, for example, a trained machine learning model.

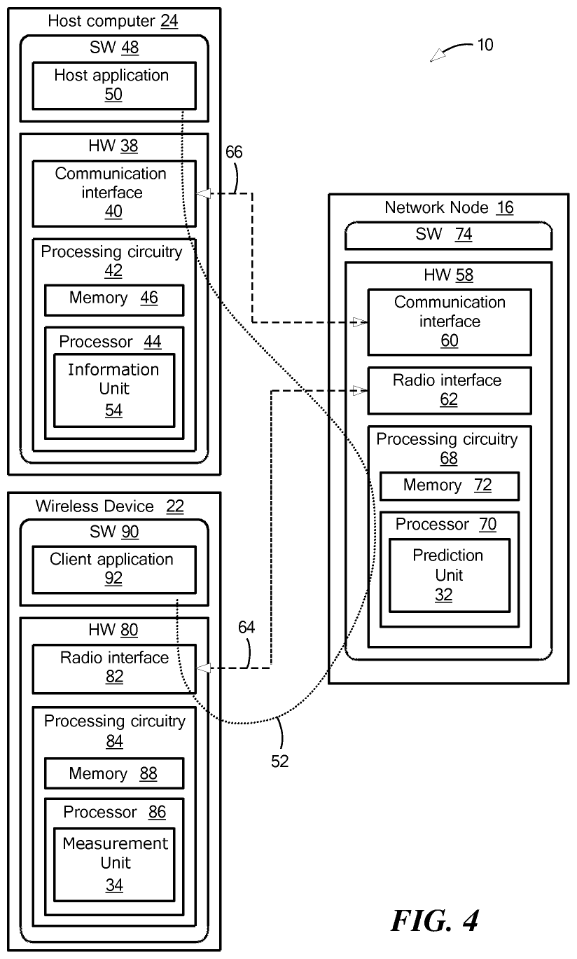

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to perform one or more of the following: process, predict, analyze, determine, measure, evaluate, receive, transmit, relay, forward, etc., information related to, for example, beam pair link prediction using, for example, a trained machine learning model.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. For example, radio interface 62 may be configured to generate one or more beams using one or more antenna arrays (not shown). The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include prediction unit 32 configured to perform one or more network node 16 functions as described herein such as with respect to, for example, beam pair link prediction using, for example, a trained machine learning model.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers. For example, radio interface 82 may be configured to generate one or more beams using one or more antenna arrays and/or panels (not shown).

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a measurement unit 34 configured to perform one or more wireless device 22 functions as described herein such as with respect to, for example, beam pair link prediction using, for example, a trained machine learning model.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as prediction unit 32, and measurement unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

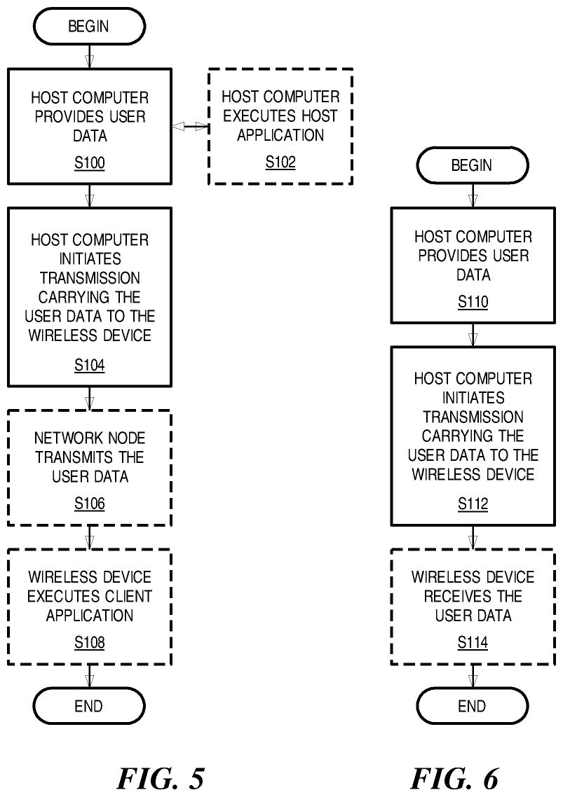

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

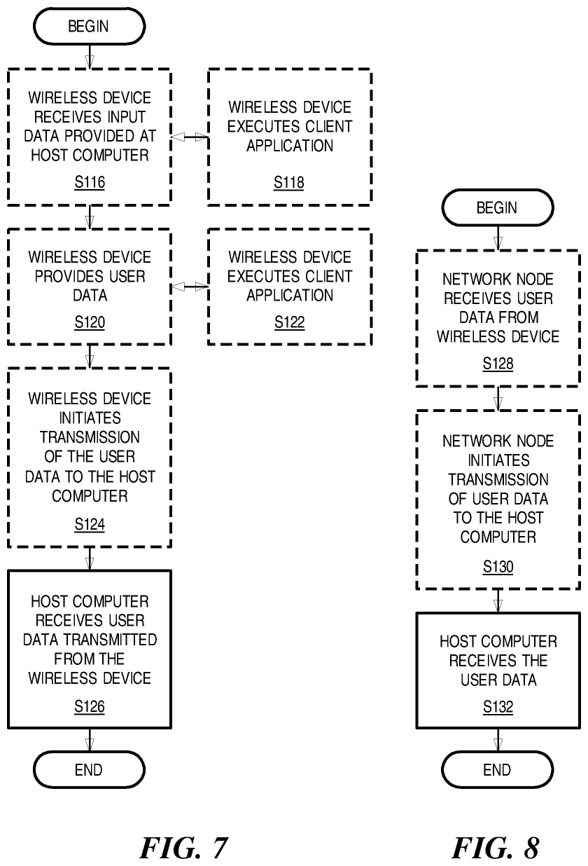

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

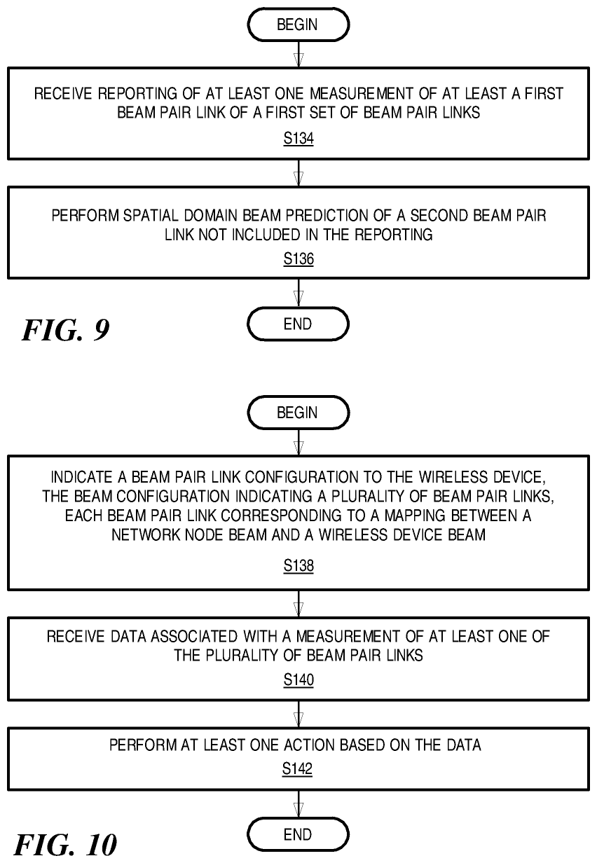

FIG. 9 is a flowchart of an example process in a network node 16 according to one or more embodiments of the present disclosure. One or more blocks described herein may be performed by one or more elements of network node 16 such as by one or more of processing circuitry 68 (including the prediction unit 32), processor 70, radio interface 62 and/or communication interface 60. Network node 16 is configured to receive (Block S134) reporting of at least one measurement of at least a first beam pair link of a first set of beam pair links, as described herein. Network node 16 is configured to perform (Block S136) spatial domain beam prediction of a second beam pair link not included in the reporting, as described herein.

According to one or more embodiments, the processing circuitry 68 is further configured to: configure the wireless device 22 to measure all beam pair links in the first set of beam pair links, receive measurements of all the beam pair links, and train a machine learning model based on the measurements of all the beam pair links, the spatial domain prediction being based on the trained machine learning model. According to one or more embodiments, the second beam pair link is associated with at least one beam characteristic of greater value than the remaining beam pair links of the first set of beam pair links. According to one or more embodiments, the processing circuitry 68 is further configured to transmit a channel state information, CSI, Beam Pair Link Report configuration indicating to the wireless device 22 how to perform measurements on downlink reference signals associated with the first set of beam pair links.

FIG. 10 is a flowchart of another example process in a network node 16 according to one or more embodiments of the present disclosure. One or more blocks described herein may be performed by one or more elements of network node 16 such as by one or more of processing circuitry 68 (including the prediction unit 32), processor 70, radio interface 62 and/or communication interface 60. Network node 16 is configured to indicate (Block S138) a beam pair link configuration to the wireless device 22, where the beam configuration indicates a plurality of beam pair links and each beam pair link corresponds to a mapping between a network node beam and a wireless device beam, as described herein. Network node 16 is configured to receive (Block S140) data associated with a measurement of at least one of the plurality of beam pair links, as described herein. Network node 16 is configured to perform (Block S142) at least one action based on the data, as described herein.

According to one or more embodiments, network node 16 is configured to transmit at least one downlink reference signal associated with a subset of the plurality of beam pair links.

According to one or more embodiments, the at least one action includes predicating channel state information, CSI, associated with a beam pair link that is not part of the at least one of the plurality of beam pair links associated with the at least one measurement.

According to one or more embodiments, the network node is further configured to: receive wireless device capability information from wireless device 22, and determine the beam pair link configuration based the wireless device capability.

According to one or more embodiments, the wireless device capability includes at least one of: a total number of wireless device beams usable for beam pair link data collection, a total number of wireless device panels usable for beam pair link data collection, a number of beams per wireless device panel usable for beam pair link data collection, a number of beams per indicated wireless device panel usable for beam pair link data collection, a number of simultaneously receiving wireless device panels, information about which beams belongs to which wireless device panel, information about which beams are usable for simultaneous reception, a configuration identifier associated with an antenna configuration and/or beam configuration, wireless device panel switching time, or antenna gain for a respective wireless device beam.

According to one or more embodiments, the network node 16 is further configured to transmit an indication to perform the at least one measurement on a subset of the plurality of beam pair links.

According to one or more embodiments, each beam pair link of the plurality of beam pair links is associated with one of: a beam pair link identifier, or a downlink reference signal, DL-RS, resource index.

According to one or more embodiments, each beam pair link of the plurality of beam pair links is associated with a wireless device beam index and a network node beam index.

According to one or more embodiments, the network node beam index is one of a downlink reference signal, DL-RS, resource index, and a DL-RS resource index associated with a repetition index.

According to one or more embodiments, the data does not include a measurement of a beam pair link that is below a predefined threshold.

According to one or more embodiments, the network node 16 is further configured to receive assistance data from the wireless device 22, where the beam pair link configuration is based at least on the assistance data, and the assistance data includes at least one of: wireless device rotation angle, wireless device position, at least one wireless device beam that is blocked, at least one wireless device panel that is blocked, or wireless antenna and/or beam configuration identifier.

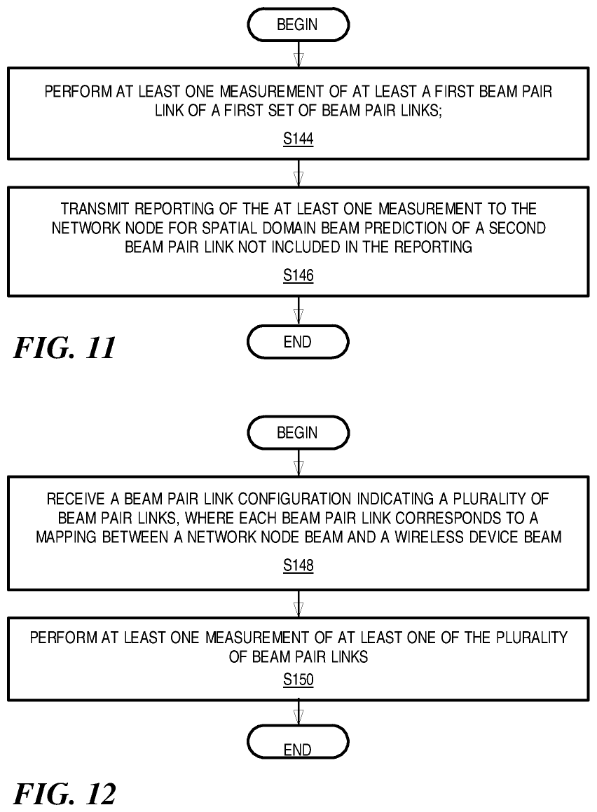

FIG. 11 is a flowchart of an example process in a wireless device 22 according to some embodiments of the present disclosure. One or more blocks described herein may be performed by one or more elements of wireless device 22 such as by one or more of processing circuitry 84 (including the measurement unit 34), processor 86, radio interface 82 and/or communication interface 60. Wireless device 22 is configured to perform (Block S144) at least one measurement of at least a first beam pair link of a first set of beam pair links, as described herein. Wireless device 22 is configured to transmit (Block S146) reporting of the at least one measurement to the network node 16 for spatial domain beam prediction of a second beam pair link not included in the reporting, as described herein.

According to one or more embodiments, the processing circuitry 84 is further configured to: receive a configuration for measuring all beam pair links in the first set of beam pair links, perform the measurements of all the beam pair links according to the configuration, and transmit reporting of the measurements of all the beam pair links for training of a machine learning model based on the measurements of all the beam pair links where the spatial domain prediction is based on the trained machine learning model. According to one or more embodiments, the second beam pair link is associated with at least one beam characteristic of greater value than the remaining beam pair links of the first set of beam pair links. According to one or more embodiments, the processing circuitry is further configured to receive a channel state information, CSI, Beam Pair Link Report configuration indicating to the wireless device 22 how to perform measurements on downlink reference signals associated with the first set of beam pair links.

FIG. 12 is a flowchart of an example process in a wireless device 22 according to some embodiments of the present disclosure. One or more blocks described herein may be performed by one or more elements of wireless device 22 such as by one or more of processing circuitry 84 (including the measurement unit 34), processor 86, radio interface 82 and/or communication interface 60. Wireless device 22 is configured to receive (Block S148) a beam pair link configuration indicating a plurality of beam pair links, where each beam pair link corresponds to a mapping between a network node beam and a wireless device beam, as described herein. Wireless device 22 is configured to perform (Block S150) at least one measurement of at least one of the plurality of beam pair links, as described herein.

According to one or more embodiments, the wireless device 22 is further configured to transmit wireless device capability information to the network node 16, and where the beam pair link configuration is configured based the wireless device capability.

According to one or more embodiments, the wireless device capability includes at least one of: a total number of wireless device beams usable for beam pair link data collection, a total number of wireless device panels usable for beam pair link data collection, a number of beams per wireless device panel usable for beam pair link data collection, a number of beams per indicated wireless device panel usable for beam pair link data collection, a number of simultaneously receiving wireless device panels, information about which beams belongs to which wireless device panel, information about which beams are usable for simultaneous reception, a configuration identifier associated with an antenna configuration and/or beam configuration, wireless device panel switching time, or antenna gain for a respective wireless device beam.

According to one or more embodiments, the wireless device 22 is further configured to receive an indication to perform the at least one measurement on a subset of the plurality of beam pair links.

According to one or more embodiments, each beam pair link of the plurality of beam pair links is associated with one of: a beam pair link identifier, or a downlink reference signal, DL-RS, resource index.

According to one or more embodiments, each beam pair link of the plurality of beam pair links is associated with a wireless device beam index and a network node beam index.

According to one or more embodiments, the network node beam index is one of: a downlink reference signal, DL-RS, resource index, and a DL-RS resource index associated with a repetition index.

According to one or more embodiments, the wireless device 22 is further configured to omit a measurement of a beam pair link from the signaled data, the omitted measurement being below a predefined threshold.

According to one or more embodiments, the wireless device 22 is further configured to transmit assistance data to the network node 16, where the beam pair link configuration is based at least on the assistance data and the assistance data includes at least one of: wireless device rotation angle, wireless device position, at least one wireless device beam that is blocked, at least one wireless device panel that is blocked, or wireless antenna and/or beam configuration identifier.

According to one or more embodiments, the wireless device 22 is configured to signal data associated with the at least one measurement, as described herein. For example, the signaling may occur sometime after one or a plurality of measurements have been taken. In one example, measurements are performed over several days and then later signaled to the network node 16.

Having described the general process flow of arrangements of the disclosure and having provided examples of hardware and software arrangements for implementing the processes and functions of the disclosure, the sections below provide details and examples of arrangements for beam pair link prediction using, for example, a trained machine learning model.

Some embodiments provide beam pair link prediction using, for example, a trained machine learning model. One or more wireless device 22 functions described below may be performed by one or more of processing circuitry 84, processor 86, measurement unit 34, radio interface 82, etc. One or more network node 16 functions described below may be performed by one or more of processing circuitry 68, processor 70, prediction unit 32, radio interface 62, etc.

In one or more embodiments, an AI/ML model for spatial domain beam prediction may be viewed as or considered as a functionality or part of a functionality that is related to spatial domain beam prediction and is deployed/implemented/configured/defined in the network node 16 side.

Further, an AI/ML model for spatial domain beam prediction can be defined as a feature or part of a feature that is related to spatial domain beam prediction and is implemented/supported in a network node 16. This network node 16 can indicate the feature version to another network node 16, e.g., a gNB. If the AI/ML model is updated, the feature version may be changed by the network node. The AI/ML model can be implemented by a neural network or other types of similar functions at, for example, network node 16.

An ML-model for spatial domain beam prediction may correspond to a function which receives one or more inputs (e.g., channel measurements on a set of beam pair links (first set of beam pair links)) and provides as outcome one or more of decision(s), estimation(s), or prediction(s) of a certain type (e.g., CSI for another set of beam pair links or second set of beam pair links).

One aspect of one or more embodiments is data collection for network node 16-sided beam pair link prediction based on DL reference signals. For this purpose, the wireless device 22 is be configured with a DL reference signal configuration within a message. This message can, for example, be an RRCReconfiguration message or an MAC CE. The DL reference configuration contains configurations of two or more DL reference signals. The DL reference signals can for example be CSI-RS, TRS, PRS or SSB. The network/network node 16 configures the wireless device 22 with a CSI Beam Pair Link Report configuration indicating to the wireless device 22 how to perform measurements on the DL reference signals. In one embodiment, each DL reference signal is associated with a wireless device 22 beam and a network node 16 beam (i.e., a beam pair link). In another embodiment, a DL-RS resource is configured with a repetition factor R, which means that the DL-RS resource is transmitted R times using the same antenna port. In this case each measurement (i.e., each beam pair link) can for example be associated with a DL-RS resource and a repetition number “r”, where the repetition number “r” can be between 1 and R. By collecting data between all beam pair links between a network node 16 and wireless device 22, the network node 16 can in a later stage ask the wireless device 22 to perform measurement and report the performance for a subset of the beam pair links, and then use an AI/ML model to predict the best or K-best beam pair link(s).

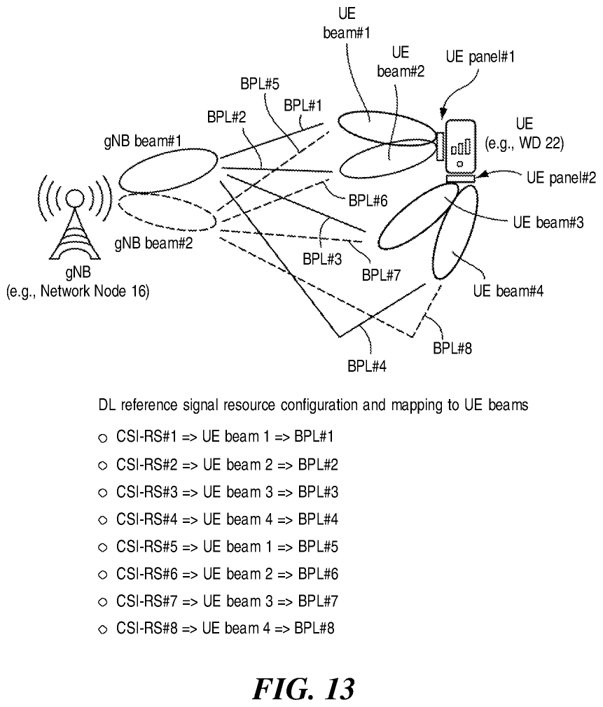

FIG. 13 illustrates a schematic example of beam pair links between a wireless device 22 (e.g., UE) and a network node 16 (e.g., gNB) according to one or more embodiments of the present disclosure. In this case the wireless device 22 is equipped with two wireless device 22 panels, and where each wireless device 22 panel has two wireless device 22 beams. Each wireless device 22 beam is associated with a wireless device 22 beam ID.

In this example, the wireless device 22 has been configured with 8 CSI-RS resources where each CSI-RS resource is associated to one of the wireless device 22 beams, such that the wireless device 22 knows which wireless device 22 beam to apply when receiving each CSI-RS resource. Since the network node 16 in this case is equipped with two network node 16 beams, there are a total of 8 candidate beam pair links (BPL #1-BPL #8). One or more embodiments described herein advantageously collects data by evaluating all the candidate beam pair links based on CSI-RS resource transmissions in all combinations of network node 16 beams and wireless device 22 beams, and lets the wireless device 22 report the measurements to the network node 16. By collecting data on all candidate beam pair links, an AI/ML model can be trained to predict a preferred beam pair link based on sounding (e.g., transmitting reference signals such as sounding reference signals) only a subset of beam pair links during inference stage. For example, assume that an AI/ML model has been trained based on measurements on all 8 candidate BPLs (e.g., a first set of beam pair links). Then, during inference, the wireless device 22 might be configured with CSI-RS measurements and report associated with only a subset of all 8 BPLs (e.g., subset of first set of beam pair links), for example only BPL #2 and BPL #7. Based on the reported performance on BPL #2 and BPL #7, the AI/ML model at the network node 16 can determine the best BPL out of all 8 BPLs. In this way the overhead signaling and latency is reduced during beam management procedures at mmWave and sub-terra Hz frequencies.

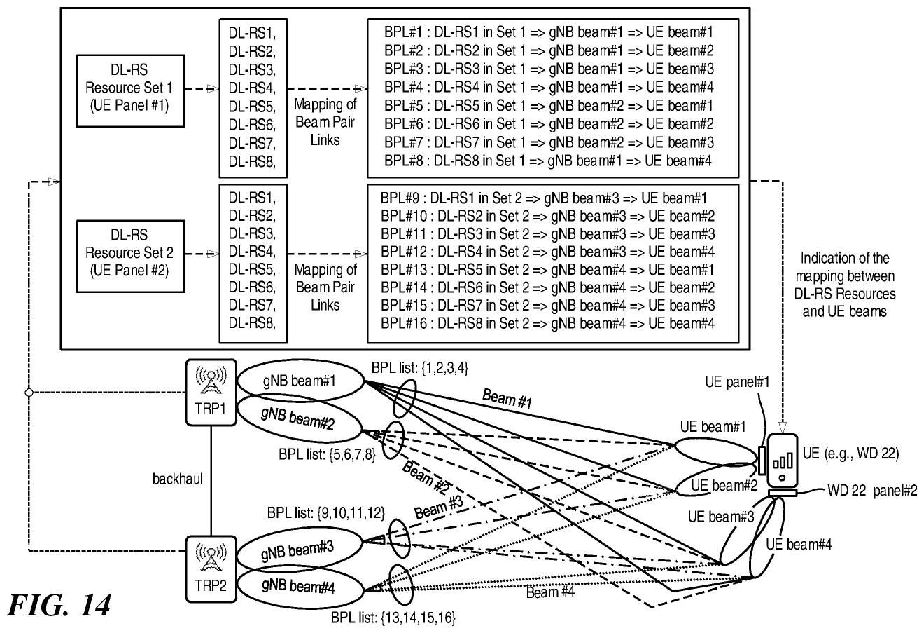

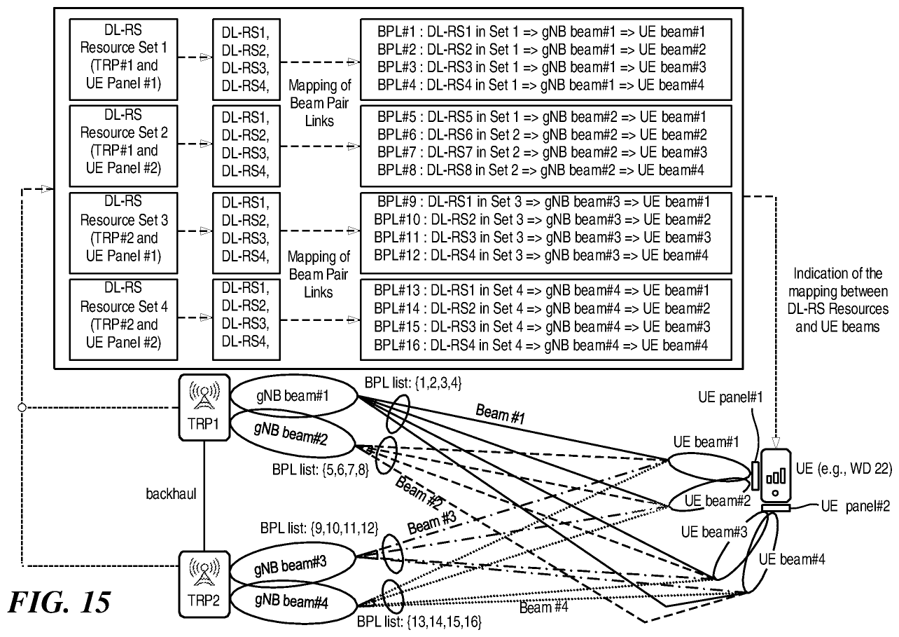

In some embodiments, the network node 16 divides the DL-RS resources into N DL-RS resource sets by considering the number of wireless device 22 antenna panels and/or the number of TRPs if D-MIMO or multi-TRPs are considered. Different associations of DL-RS resources will lead to different types of data collection for training AI/ML model.
In one embodiment, the network node 16 divides the DL-RS resources into N DL-RS resource sets, where each DL-RS resource set is associated to one wireless device 22 antenna panel, e.g., DL-RS resources in DL-RS resource set M is associated with the m-th wireless device 22 antenna panel. One benefit of this configuration/embodiment is that the network node 16 is able to more easily (compared to at least one existing method) differentiate the measurement data collected from different panels at the wireless device 22. In addition, for D-MIMO or multi-TRPs, the wireless device 22 does not know the DL-RSs are from which TRPs. So, the mapping determined by the network node 16 will reduce the signaling complexity. An example of a multi-TRPs scenario is illustrated in FIG. 14, where the mapping between DL-RS resources to the wireless device 22 beams is determined by the network node 16 taking only the number of wireless device 22 panels into account. In this case, there are 2 DL-RS resource sets as there are only 2 wireless device 22 antenna panels. The DL-RS resource set 1 is associated with the wireless device 22 antenna panel #1 and the DL-RS resource set 2 is associated with the wireless device 22 antenna panel #2.
In one embodiment, the network node 16 divides the DL-RS resources into N DL-RS resource sets, where each DL-RS resource set is associated to one TRP, e.g., DL-RS resources in DL-RS resource set M is associated with the m-th TRP. An example of a multi-TRPs scenario illustrated in FIG. 14, where the mapping between DL-RS resources to wireless device 22 (e.g., UE) beams is determined by the network node 16 (e.g., gNB) taking only the number of TRPs into account. In particular, FIG. 14 is reused as there are same number of TRPs and the number of wireless devices 22 antenna panels in FIG. 14. In this case, there are 2 DL-RS resource sets as there are only 2 TRPs. The DL-RS resource set 1 is associated with the TRP #1 and the DL-RS resource set 2 is associated with the TRP #2.
In one embodiment, the network node 16 divides the DL-RS resources into P*N DL-RS resource sets, wherein each DL-RS resource set is associated with one TRP and one wireless device 22 antenna panel, e.g., DL-RS resources in DL-RS resource set M is associated with the m-th TRP and m-th the wireless device 22 antenna panel. An example of multi-TRPs scenario for determining the mapping between DL-RS resources to wireless device 22 beams determined by the network node 16 taking both the number of TRPs and the number of wireless device 22 panels into account is illustrated in FIG. 15. The mapping between DL-RS resources to wireless device 22 beams is determined by the network node 16 taking both the number of TRPs and the number of wireless device 22 panels into account. In this case, there are 4 DL-RS resource sets as there are only 2 TRPs and 2 wireless device 22 antenna panels. DL-RS resource sets {1,2,3,4} is associated to {TRP #1, UE panel #1}, {TRP #1, UE panel #2}, {TRP #2, UE panel #1}, and {TRP #2, UE panel #2}, respectively.

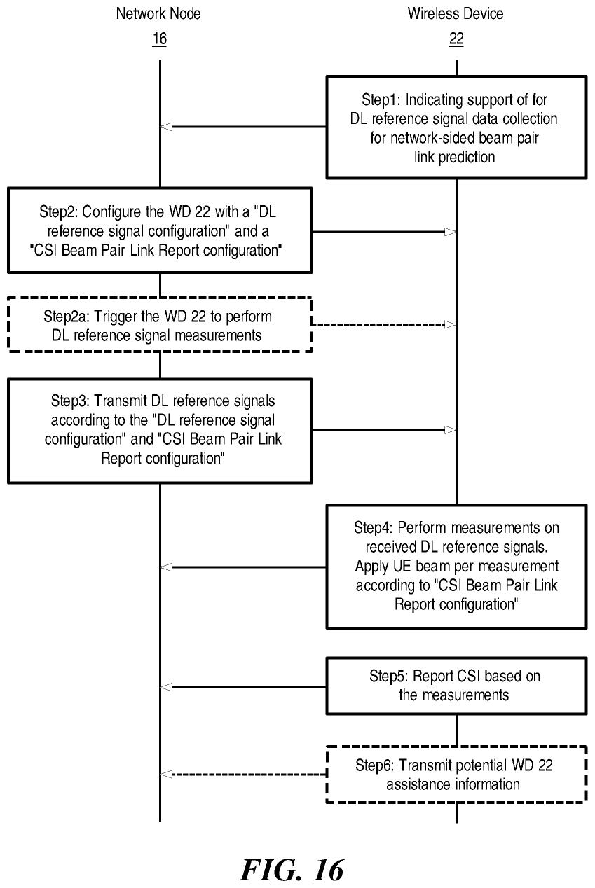

FIG. 16 is a flowchart of an example process according to one or more embodiments of the present disclosure. In Step1 the wireless device 22 reports, for example during wireless device 22 capability signaling, support for DL reference signal data collection for network-sided beam pair link prediction.

The wireless device 22 capability signaling can, for example, include one or more of the following information:
Total number of wireless device 22 beams to use for beam pair link data collection
Total number of wireless device 22 panels to use for beam pair link data collection
One single number of beams indicating the number of beams per panel to use for beam pair link data collection (assuming each panel has the same number of beams)
One single number of beams per indicated wireless device 22 panel to use for beam pair link data collection
Number of simultaneously receiving beams/panels (i.e. how many beams/panels the wireless device 22 can receive with simultaneously)
Information about which beams that belongs to which wireless device 22 panel
Information about which beams/panels that could be used for simultaneous reception
A “UE antenna/beam configuration ID” associated with the wireless devices 22 antenna configuration and/or beam configuration (including the association between a wireless device 22 beam and a wireless device 22 beam ID).
   The “UE antenna/beam configuration ID” can be used as input to the AI/ML model
wireless device 22 panel switching time
Antenna gain for respective wireless device 22 beam.

In Step2, the network node 16 indicates the relevant configurations for the DL reference signal data collection for network node 16-sided beam pair link prediction, for example a “DL reference signal configuration”, a “CSI Beam Pair Link Report configuration”. The “DL reference signal configuration” can for example include of one or more of:
Resource Setting (e.g., CSI-ResourceConfig as specified in, for example, 3GPP TS 38.311)
CSI-RS resource sets (e.g., NZP-CSI-RS-ResourceSet as specified in, for example, 3GPP TS 38.311)
SSB resource sets (e.g., CSI-SSB-ResourceSet as specified in, for example, 3GPP TS 38.311)
CSI-RS resources (e.g., NZP-CSI-RS-Resource as specified in, for example, 3GPP TS 38.311)
New potential DL-RS resource configuration for 6G

The “CSI Beam Pair Link Report configuration” can for example includes of one or more of:
Report Setting (e.g., CSI-ReportConfig as specified in, for example, 3GPP TS 38.311)
New potential CSI report configuration for 6G

In Step3 the network node 16 transmits the DL-RSs.

In Step4, the wireless device 22 perform measurements on the received DL-RSs. During the reception of the DL-RS, the wireless device 22 sweeps through different wireless device 22 beams according to indications from the network node 16, for example in “CSI Beam Pair Link Report configuration”.

In Step5, the wireless device 22 reports all or a subset of all beam pair links/DL-reference signal IDs, and a corresponding performance metric per beam pair link/DL-reference signal ID.

In Step6, the wireless device 22 transmits additional wireless device 22 assistance information associated with the report, where the additional wireless device 22 assistance information for example can consist of one or more of:
Wireless device 22 rotation angle (in global coordination system)
Wireless device 22 position
Which beams that are blocked by human body
Which panels that are blocked by human body
Estimate of whether the measurement was subject of blockage
   Probability that the blockage that is expected to be static (wall or fixed object)
   Probability of dynamic blockage, such as the blocking due to body (face/hand) for smartphones—Also indicate, if capable, a forecast of how long such blockage is expected.
Estimate of the signal quality of the measurement event if the wireless device was not subject to dynamic blockage at the given location.
Estimate of probability that the wireless device is located indoors
   Using radio-measurements (e.g., analyze delay spread)
   Non-radio measurements such as light sensors, which can be used to detect whether the wireless device 22 is indoors. For example, the wireless device 22 uses the light sensor/camera to measure the ambient light, which is used to classify whether the wireless device 22 is indoors or outdoors. The sensor can for example measure the light intensity, but it can also analyze the spectral properties of the ambient light to identify characteristics of light bulbs, LEDs, fluorescent light, halogen lights or other light sources typically found indoors. An indication whether the wireless device 22 has moved from outdoor to indoor or vice versa can thus be estimated using the light sensors.

Another information part of the wireless device 22 assistance information can include wireless device 22 reports a “UE antenna gain compensated RSRP” for each reported beam (DL-RS index) in a beam report. The “UE antenna gain compensated RSRP” can for example be calculated as “normal RSRP” (as specified in, for example, 3GPP TS 38.133) minus the maximum antenna gain for the spatial filter used when receiving the indicated DL-RS. In one embodiment, the “UE antenna gain compensated RSRP” can be used instead of the normal RSRP. In one embodiment, other factors like for example estimated hand/body blockage loss is also included in the “UE antenna gain compensated RSRP”. In this case the “UE antenna gains compensated RSRP” can be calculated as “normal RSRP” (as specified in, for example, 3GPP TS 38.133) minus the maximum antenna gain for the spatial filter used when receiving the indicated DL-RS minus the estimated hand/body blockage loss. The use of a compensated RSRP is to create a database of samples that are agonistic to the dynamic environment, i.e. that only captures the static nature of the environment.

### SOME EXAMPLES

1. A method in a wireless device 22 for collecting data at a network node 16 based on DL reference signals, where the data is used at the network node 16 for training an AI/ML model for predicting one or multiple beam pair links between the network node 16 and the wireless device 22, the method includes:
   a. receiving a message containing a field DL reference signal configuration, wherein the DL reference signal configuration, that configures two or more reference signal resources,
   b. receiving a message containing a field CSI Beam Pair Link Report configuration, wherein the CSI Beam Pair Link Report configuration that is associated with the DL reference signal configuration; and
   c. receiving a trigger message to measure according to the CSI Beam Pair Link Report configuration,
   d. perform the measurements
   e. report CSI based on the measurements
   f. (Optional) provide network node 16 with UE assistance information in association with the report.
2. The method of Example 1 where the wireless device 22 sends a capability to the network node 16 indicating support for DL reference signal data collection for network-sided beam pair link prediction, the capability can in addition indicate one or more of the following:
   a. Total number of wireless device 22 beams to use for beam pair link data collection
   b. Total number of wireless device 22 panels to use for beam pair link data collection
   c. One single number of beams indicating the number of beams per panel to use for beam pair link data collection (assuming each panel has the same number of beams)
   d. One single number of beams per indicated wireless device 22 panel to use for beam pair link data collection
   e. Number of simultaneously receiving beams/panels (i.e. how many beams/panels the wireless device 22 can receive with simultaneously)
   f. Information about which beams that belongs to which wireless device 22 panel
   g. Information about which beams/panels that could be used for simultaneous reception
   h. A “UE antenna/beam configuration ID” associated with the wireless devices 22 antenna configuration and/or beam configuration (including the association between a wireless device beam and a wireless device 22 beam ID).
      i. The “UE antenna/beam configuration ID” can be used as input to the AI/ML model
   i. Wireless device 22 panel switching time
   j. Antenna gain for respective wireless device 22 beam.
3. The method of Example 1 where the CSI Beam Pair Link Report configuration indicates which wireless device 22 beam the wireless device 22 should apply for respective measurement of the DL reference signals.
4. The method of Example 3 where the CSI Beam Pair Link Report configuration indicates a one-to-one mapping between a DL-RS resource and a wireless device 22 beam.
5. The method of Example 4 where the indication is provided by a list of pairs, where each pair consist of one DL-RS resource ID and on UE (wireless device 22) Beam ID
6. The method of one or more of Examples 4 and 5 where each DL-RS resource is associated with one beam pair link, and the wireless device 22 reports one performance metric for all or a subset of all beam pair links.
7. The method of Example 6 where a DL-RS ID is associated with each reported beam pair link.
8. The method of one or more of Examples 6 and 7 where beam pair links below a certain performance threshold is omitted from the report.
9. The method of Example 1 where a DL-RS can be configured with a repetition factor R, such that the same DL-RS resource is transmitted repeatedly using the same antenna port in R consecutive symbols (e.g., OFDM symbols).
10. The method of Example 9 where a gap period of one or more symbols (e.g., OFDM symbols) can be configured between all or a subset of all R repetitions.
11. The method of Example 9 where the wireless device 22 sweeps different wireless device 22 beams for each repetition of the DL-RS resource.
12. The method of one or more of Examples 9 and 11 where each DL-RS resource and repetition occasion of that DL-RS resource constitutes one beam pair link, and where the wireless device 22 reports one performance metric for all or a subset of all beam pair links.
13. The method of Example 12 where a beam pair link ID is introduced, and used to indicate which beam pair links that is included in the report.
14. The method of one or more of Examples 12 and 13 where beam pair links below a certain performance threshold are omitted from the report.
15. The method of Example 1 where the wireless device 22 (e.g., UE) transmits UE assistance information to the network node 16 in association with a report, where the UE assistance information could contain one or more of:
   a. Wireless device 22 rotation angle
   b. Wireless device 22 position
   c. Which wireless device 22 beams that are blocked by human body
   d. Which wireless device 22 panels that are blocked by human body
   e. “UE antenna/beam configuration ID.”
16. The method of Example 1 where the CSI Beam Pair Link Report configuration contains a field Report setting, where the Report setting is associated with the two DL reference signal configuration.
17. The method of Example 16 where the Report setting contains a field “Report Quantity”, where the “Report Quantity” indicates that the wireless device 22 should report the indicated beam pair links and associated performance metrics.
18. The method of Example 1 where the network node 16 is at least one of the following eNB, gNB, IAB, or base station, as described herein.
19. The method of Example 1 where the DL-reference signal resources are CSI-RS resources.

One or more embodiments described herein provide one or more of the following advantages/benefits.

One or more embodiments advantageously enables data collection of beam pair link prediction at network node 16 side for 5G advance and/or 6G, which could be used to train an AI/ML model to predict a preferred beam pair link based on measurements on a subset of all beam pair links. By only measuring a subset of all beam pair links, the overhead and latency during beam management procedures for mmWave and sub-terra HZ communication will reduce compared to measuring on all beam pair links (measuring all beam pair links might not be reasonable with respect to overhead and latency, due to the significant amount of beam pair links that might exist between a network node 16 and wireless device 22).

One benefit with determining preferred beam pair link instead of, for example, determining a preferred network node 16 beam is that it usually takes a long time for the wireless device 22 to determine a suitable wireless device 22 beam for a given network node 16 beam. Commercial mmWave measurements systems can take up to 1 sec for a wireless device 22 to find a suitable wireless device 22 beam. In case a wireless device 22 is moving/rotating, the delay of one second to find a suitable wireless device 22 beam, will significantly reduce the performance. By directly determining a beam pair link, i.e., a network node 16 beam and wireless device 22 beam, the latency of a beam finding procedure can be significantly reduced, and the performance for moving/rotating wireless device 22 significantly increased.

### SOME ADDITIONAL EXAMPLES

Example A1. A network node 16 configured to communicate with a wireless device 22, the network node 16 configured to, and/or comprising a radio interface 62 and/or comprising processing circuitry 68 configured to:
receive reporting of at least one measurement of at least a first beam pair link of a first set of beam pair links; and
perform spatial domain beam prediction of a second beam pair link not included in the reporting.
Example A2. The network node 16 of Example A1, wherein the processing circuitry 68 is further configured to:
configure the wireless device 22 to measure all beam pair links in the first set of beam pair links;
receive measurements of all the beam pair links;
train a machine learning model based on the measurements of all the beam pair links, the spatial domain prediction being based on the trained machine learning model.
Example A3. The network node 16 of Example A1, wherein the second beam pair link is associated with at least one beam characteristic of greater value than the remaining beam pair links of the first set of beam pair links.
Example A4. The network node 16 of Example A1, wherein the processing circuitry 68 is further configured to transmit a channel state information, CSI, Beam Pair Link Report configuration indicating to the wireless device 22 how to perform measurements on downlink reference signals associated with the first set of beam pair links.
Example B1. A method implemented in a network node 16 that is configured to communicate with a wireless device 22, the method comprising:
receiving reporting of at least one measurement of at least a first beam pair link of a first set of beam pair links; and
performing spatial domain beam prediction of a second beam pair link not included in the reporting.
Example B2. The method of Example B1, further comprising:
configuring the wireless device 22 to measure all beam pair links in the first set of beam pair links;
receiving measurements of all the beam pair links; and
training a machine learning model based on the measurements of all the beam pair links, the spatial domain prediction being based on the trained machine learning model.
Example B3. The method of Example B1, wherein the second beam pair link is associated with at least one beam characteristic of greater value than the remaining beam pair links of the first set of beam pair links.
Example B4. The method of Example B1, further comprising transmitting a channel state information, CSI, Beam Pair Link Report configuration indicating to the wireless device 22 how to perform measurements on downlink reference signals associated with the first set of beam pair links.
Example C1. A wireless device 22 configured to communicate with a network node 16, the wireless device 22 configured to, and/or comprising a radio interface 62 and/or processing circuitry 68 configured to:
perform at least one measurement of at least a first beam pair link of a first set of beam pair links; and
transmit reporting of the at least one measurement to the network node 16 for spatial domain beam prediction of a second beam pair link not included in the reporting.
Example C2. The wireless device 22 of Example C1, wherein the processing circuitry 84 is further configured to:
receive a configuration for measuring all beam pair links in the first set of beam pair links;
perform the measurements of all the beam pair links according to the configuration;
transmit reporting of the measurements of all the beam pair links for training of a machine learning model based on the measurements of all the beam pair links, the spatial domain prediction being based on the trained machine learning model.
Example C3. The wireless device 22 of Example C1, wherein the second beam pair link is associated with at least one beam characteristic of greater value than the remaining beam pair links of the first set of beam pair links.
Example C4. The wireless device 22 of Example C1, wherein the processing circuitry 84 is further configured to receive a channel state information, CSI, Beam Pair Link Report configuration indicating to the wireless device 22 how to perform measurements on downlink reference signals associated with the first set of beam pair links.
Example D1. A method implemented in a wireless device 22 (WD 22), the method comprising:
performing at least one measurement of at least a first beam pair link of a first set of beam pair links; and
transmitting reporting of the at least one measurement to the network node 16 for spatial domain beam prediction of a second beam pair link not included in the reporting.
Example D2. The method of Example D1, further comprising:
receiving a configuration for measuring all beam pair links in the first set of beam pair links;
performing the measurements of all the beam pair links according to the configuration;
transmitting reporting of the measurements of all the beam pair links for training of a machine learning model based on the measurements of all the beam pair links, the spatial domain prediction being based on the trained machine learning model.
Example D3. The method of Example D1, wherein the second beam pair link is associated with at least one beam characteristic of greater value than the remaining beam pair links of the first set of beam pair links.
Example D4. The method of Example D1, further comprising receiving a channel state information, CSI, Beam Pair Link Report configuration indicating to the wireless device 22 how to perform measurements on downlink reference signals associated with the first set of beam pair links.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviations | Explanation |
|---|---|
| 3GPP | 3rd Generation Partnership Project |
| 5G | Fifth Generation |
| ACK | Acknowledgement |
| AI | Artificial Intelligence |
| AoA | Angle of Arrival |
| CORESET | Control Resource Set |
| CSI | Channel State Information |
| CSI-RS | CSI Reference Signal |
| DCI | Downlink Control Information |
| DoA | Direction of Arrival |
| DL | Downlink |
| DMRS | Downlink Demodulation Reference Signals |
| FDD | Frequency-Division Duplex |
| FR2 | Frequency Range 2 |
| HARQ | Hybrid Automatic Repeat Request |
| ID | identity |
| gNB | gNodeB |
| MAC | Medium Access Control |
| MAC-CE | MAC Control Element |
| ML | Machine Learning |
| NR | New Radio |
| NW | Network |
| OFDM | Orthogonal Frequency Division Multiplexing |
| PBCH | Physical Broadcast Channel |
| PCI | Physical Cell Identity |
| PDCCH | Physical Downlink Control Channel |
| PDSCH | Physical Downlink Shared Channel |
| PRB | Physical Resource Block |
| QCL | Quasi co-located |
| RB | Resource Block |
| RRC | Radio Resource Control |
| RSRP | Reference Signal Strength Indicator |
| RSRQ | Reference Signal Received Quality |
| RSSI | Received Signal Strength Indicator |
| SCS | Subcarrier Spacing |
| SINR | Signal to Interference plus Noise Ratio |
| SSB | Synchronization Signal Block |
| RL | Reinforcement Learning |
| RS | Reference Signal |
| Rx | Receiver |
| TB | Transport Block |
| TDD | Time-Division Duplex |
| TCI | Transmission configuration indication |
| TRP | Transmission/Reception Point |
| Tx | Transmitter |
| UE | User Equipment |
| UL | Uplink |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented by a wireless device that is configured to communicate with a network node, the method comprising:
receiving a beam pair link configuration indicating a plurality of beam pair links, each beam pair link corresponding to a mapping between a network node beam and a wireless device beam; and
performing at least one measurement of at least one of the plurality of beam pair links.

2. The method of claim 1, further comprising transmitting wireless device capability information to the network node; and
the beam pair link configuration being configured based the wireless device capability.

3. The method of claim 2, wherein the wireless device capability includes at least one of:
a total number of wireless device beams usable for beam pair link data collection;
a total number of wireless device panels usable for beam pair link data collection;
a number of beams per wireless device panel usable for beam pair link data collection;
a number of beams per indicated wireless device panel usable for beam pair link data collection;
a number of simultaneously receiving wireless device panels;
information about which beams belongs to which wireless device panel;
information about which beams are usable for simultaneous reception;
a configuration identifier associated with an antenna configuration and/or beam configuration;
wireless device panel switching time; or
antenna gain for a respective wireless device beam.

4. The method of claim 1, further comprising receiving an indication to perform the at least one measurement on a subset of the plurality of beam pair links.

5. The method of claim 1, wherein each beam pair link of the plurality of beam pair links is associated with one of:
a beam pair link identifier; or
a downlink reference signal, DL-RS, resource index.

6. The method of claim 1, wherein each beam pair link of the plurality of beam pair links is associated with a wireless device beam index and a network node beam index.

7. The method of claim 6, wherein the network node beam index is one of:
a downlink reference signal, DL-RS, resource index; or
a DL-RS resource index associated with a repetition index.

8. The method of claim 1, further comprising transmitting assistance data to the network node, the beam pair link configuration being based at least on the assistance data, the assistance data including at least one of:
wireless device rotation angle;
wireless device position;
at least one wireless device beam that is blocked;
at least one wireless device panel that is blocked; or
wireless antenna and/or beam configuration identifier.

9. The method of claim 1, further comprising signaling data associated with the at least one measurement.

10. The method of claim 9, further comprising omitting a measurement of a beam pair link from the signaled data, the omitted measurement being below a predefined threshold.

11. A wireless device configured to:
receive a beam pair link configuration indicating a plurality of beam pair links, each beam pair link corresponding to a mapping between a network node beam and a wireless device beam; and
perform at least one measurement of at least one of the plurality of beam pair links.

12.-20. (canceled)

21. A method implemented by a network node that is configured to communicate with a wireless device, the method comprising:
indicating a beam pair link configuration to the wireless device, the beam configuration indicating a plurality of beam pair links, each beam pair link corresponding to a mapping between a network node beam and a wireless device beam;
receiving data associated with a measurement of at least one of the plurality of beam pair links; and
performing at least one action based on the data.

22. The method of claim 21, further comprising transmitting at least one downlink reference signal associated with a subset of the plurality of beam pair links.

23. The method of claim 21, wherein the at least one action includes predicating channel state information, CSI, associated with a beam pair link that is not part of the at least one of the plurality of beam pair links associated with the at least one measurement.

24. The method of claim 21, further comprising:
receiving wireless device capability information from the wireless device; and
determining the beam pair link configuration based the wireless device capability.

25. The method of claim 24, wherein the wireless device capability includes at least one of:
a total number of wireless device beams usable for beam pair link data collection;
a total number of wireless device panels usable for beam pair link data collection;
a number of beams per wireless device panel usable for beam pair link data collection;
a number of beams per indicated wireless device panel usable for beam pair link data collection;
a number of simultaneously receiving wireless device panels;
information about which beams belongs to which wireless device panel;
information about which beams are usable for simultaneous reception;
a configuration identifier associated with an antenna configuration and/or beam configuration;
wireless device panel switching time; or
antenna gain for a respective wireless device beam.

26. The method of claim 21, further comprising transmitting an indication to perform the at least one measurement on a subset of the plurality of beam pair links.

27. The method of claim 21, wherein each beam pair link of the plurality of beam pair links is associated with one of:
a beam pair link identifier; or
a downlink reference signal, DL-RS, resource index.

28. The method of claim 21, wherein each beam pair link of the plurality of beam pair links is associated with a wireless device beam index and a network node beam index.

29.-31. (canceled)

32. A network node configured to communicate with a wireless device, the network node configured to:
indicate a beam pair link configuration to the wireless device, the beam configuration indicating a plurality of beam pair links, each beam pair link corresponding to a mapping between a network node beam and a wireless device beam;
receive data associated with a measurement of at least one of the plurality of beam pair links; and
perform at least one action based on the data.

33.-42. (canceled)
